(19) United States
(12) Patent Application Publication
(10) Pub. No.: US 2013/0065096 A1
(43) Pub. Date: Mar. 14, 2013

(54) ALKALINE BATTERY AND CLOSURE ASSEMBLY THEREFOR

(71) Applicant: Josef Daniel-Ivad, Richmod Hill (CA)

(72) Inventor: Josef Daniel-Ivad, Richmod Hill (CA)

(21) Appl. No.: 13/699,604

(22) PCT Filed: May 18, 2011
(86) PCT No.: PCT/CA2011/000582

§ 371 Date: Nov. 21, 2012

Related U.S. Application Data
(60) Provisional application No. 61/347,245, filed on May 21, 2010.

(51) Int. Cl. H01M 2/12; H01M 2/20

(52) U.S. Cl. 429/56; 429/61

(57) ABSTRACT

The present invention relates to electrochemical cells and to closure assemblies for aqueous alkaline electrolyte cells of the conventional cylindrical type. The closure assembly is for the negative terminal and comprises an internal cap disc in unsecured electrical contact with an internal cap ring. When pressure within the cell increases, for example due to gas generation by electrolysis of the electrolyte through abuse or overcharging, the cap disc moves away from the cap ring, breaking the electrical contact and disrupting the electrochemical circuit within the cell. This prevents further gas generation and pressure build-up, thereby preventing a failure of the internal blow out safety vent and escape of the corrosive electrolyte. In time, the pressure dissipates and the cap disc again makes contact with the cap ring, permitting the cell to be used again.

### FIELD OF THE INVENTION

The present invention relates to electrochemical cells, particularly aqueous alkaline electrochemical cells or batteries, and to closure assemblies therefor with improved abuse leakage resistance.

### BACKGROUND

Batteries, particularly of the AA and AAA variety, have become increasingly popular over the last decade due to the advent of a myriad of portable electronic devices. Primary, single-use (non-rechargeable) and secondary (rechargeable) batteries in various battery chemistries are available for use with different portable electronic devices. For primary batteries, the alkaline battery is the most widely used and dominates the market place. Rechargeable alkaline batteries have become available as substitutes for single-use alkaline batteries with the added benefit of rechargeability.

Alkaline batteries, single-use and rechargeable, have an aqueous alkaline electrolyte with high concentration and strength, which is highly corrosive and can lead to personal injury and property damage in the event of leakage. Therefore, the leak-tightness or seal integrity of alkaline batteries is of outmost importance. Excellent leak-tightness has been achieved by most manufacturers to date, resulting in the market dominance of the alkaline battery chemistry. However, under abuse situations, such as over-charging in rechargeable cells, electrolyte leakage in alkaline batteries is an accepted failure mode to prevent a full explosion. Abuse situations may be applied unintentionally by the consumer due to mixing of old and new cells, mixing of battery chemistries, incorrect battery installation and other such situations.

U.S. Pat. No. 3,617,386 describes a sealed battery cell having a single plastic member which seals the cell, insulates the cell terminal, provides a hydrogen gas permeable diaphragm, a circuit opening actuator and a pressure frangible safety device. No commercial alkaline cell was ever produced using this principle, likely due to the overall poor leak-tightness of this design.

U.S. Pat. No. 5,478,669 describes an improved closure assembly for aqueous alkaline electrolyte cylindrical cells that provides for better leakage proof properties of mercury-free alkaline primary or rechargeable cells. However, this design cannot prevent leakage under abuse conditions.

A number of approaches for current interrupt devices have been described for batteries with jelly-roll, wound electrode assemblies (as are common in dry cell batteries, such as NiCd, and non-aqueous electrolyte lithium batteries) for interrupting current at the positive terminal of the battery cell. There are a number of mechanical differences between interrupting current at the positive terminal and at the negative terminal of a cell. U.S. Pat. No. 7,527,890 teaches a sealed alkaline storage battery including a nickel electrode as a positive electrode capable of being charged within a specified pressure and temperature range. U.S. Pat. Nos. 6,878,481 and 7,288,920 describe a fast cell charging system on the example of a nickel metal hydride (NiMH) rechargeable battery and charger wherein the cell stops charging at a predetermined internal cell pressure by means of a current interrupt device. US Patent Application Publication 2007/0275298 teaches a current interrupt device for a lithium iron disulfide (Li—FeS₂) primary battery cell. All these approaches require more or less manual operations and are not well suited for high speed automated manufacturing.

While a number of solutions are available for current interrupt devices within the positive terminal of batteries, particularly NiMH, NiCd and Lithium batteries, there is a need for a current interrupt device incorporated into the negative terminal of an alkaline battery to minimize leakage under consumer abuse/misuse conditions. It would be desirable that such a battery were amenable to manufacturing on automated high speed production lines.

### SUMMARY OF THE INVENTION

According to an aspect of the invention, there is provided a sealed electrochemical cell containing an aqueous alkaline electrolyte, the cell comprising: a cylindrical can; a positive terminal; a negative terminal comprising a negative terminal closure assembly, the negative terminal closure assembly comprising a negative terminal end cap, a negative cap disc located within an interior of the cell spaced apart from the negative terminal end cap, a negative cap ring electrically connected to the negative terminal end cap, at least a portion of the negative cap ring in unsecured electrical contact with the negative cap disc; a current collector nail within the cell electrically connected to the negative cap disc that completes an electric circuit between the positive and negative terminals of the cell; and, wherein the negative cap disc is movable away from the negative cap ring in response to an increase in internal cell pressure to thereby electrically disconnect the negative cap disc from the negative terminal end cap and interrupt the electric circuit within the cell.

According to another aspect of the invention, there is provided a negative terminal closure assembly for a sealed electrochemical cell containing an aqueous alkaline electrolyte, the cell comprising a cylindrical can, a positive terminal, and a negative terminal, the negative terminal closure assembly comprising: a negative terminal end cap, a negative cap disc located within an interior of the cell adjacent to and spaced apart from the negative terminal end cap, the negative cap disc in unsecured electrical contact with a negative cap ring or portion thereof that is electrically connected to the negative terminal end cap, the negative cap disc electrically connected to a current collector nail within the cell that completes an electric circuit between the positive and negative terminals of the cell, the negative cap disc movable away from the negative cap ring in response to an increase in internal cell pressure to thereby electrically disconnect the negative cap disc from the negative terminal end cap and interrupt the electric circuit within the cell.

According to yet another aspect of the invention, there is provided a method of manufacturing a sealed electrochemical cell comprising a cylindrical can containing a hollow cylindrical cathode, an anode gel within the hollow portion of the cathode and a permeable separator between the anode and cathode, the can containing an aqueous alkaline electrolyte and having a radial bead formed about its circumference above the cathode, the method comprising: providing a deformable top seal comprising a first undercut and a second undercut; retaining a cap ring on the seal using the second undercut; inserting a current collector nail through a central portion of the seal and securing the nail to a negative cap disc, the negative cap disc in contact with an upper surface of the cap ring; placing a negative terminal end cap covering the negative cap disc atop an outer edge portion of the cap ring spaced apart from the cap disc and retaining the end cap on the seal using the first undercut; inserting the seal into the can into abutment with the bead, the nail extending into the hollow center of the cathode through the anode gel; and, crimping an upper end portion of the can over a bent rim of the negative terminal end cap, such that the seal is compressed between the cap ring and the bead.

### BRIEF DESCRIPTION OF THE DRAWINGS

Having summarized the invention, preferred embodiments thereof will now be described with reference to the accompanying drawings, in which:

FIG. 1 shows a sectional view of an LR6 cell made according to the invention;

FIG. 2 shows an enlarged view of the upper portion of an LR6 closure assembly according to the invention;

FIG. 3 shows an enlarged view of the upper portion of an LR6 cell according to the invention in an electrical disconnect state;

FIGS. 4a-c depict different disc types according to the invention, with FIG. 4a showing a flat disc, FIG. 4b showing a disc with concentric waved ribs, and FIG. 4c showing a disc with concentric ribs plus a lip curl on the inside diameter;

FIG. 5 shows an enlarged upper portion of an LR03 closure assembly according to the invention; and,

FIG. 6 shows a prior art LR6 closure assembly for reference.

### DETAILED DESCRIPTION OF PREFERRED EMBODIMENTS

In the drawings, like reference numerals will be used to describe like features common to all embodiments. Accordingly, features shown on a particular drawing may be described with reference to another drawing.

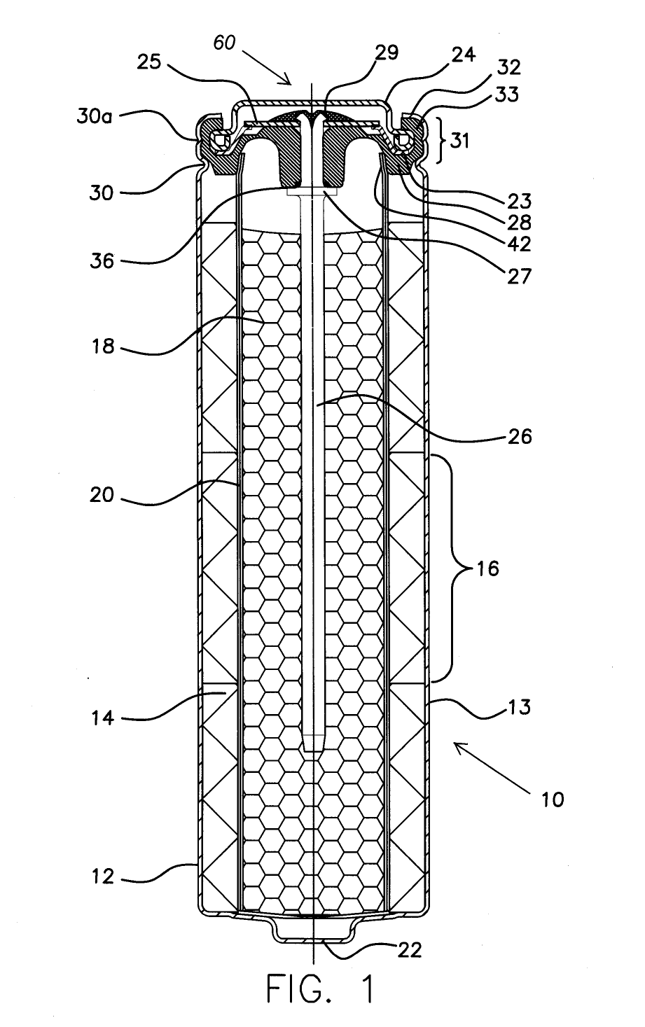

FIG. 1 shows an LR6 size (AA type) alkaline manganese dioxide-zinc cell 10. The cell comprises the following main units: a steel can 12 defining a cylindrical inner space, a carbon coating 13 applied to the inner surface of can 12, a manganese dioxide cathode 14 formed by a plurality of hollow cylindrical pellets 16 pressed in the can, a zinc anode 18 made of an anode gel and arranged in the hollow interior of the cathode 14, and a cylindrical separator 20 separating the anode 18 from the cathode 14. The ionic conductivity between the anode and the cathode is provided by the presence of an aqueous potassium hydroxide (KOH) electrolyte solution added into the cell in a predetermined quantity.

The can 12 is closed at the bottom and it has a central circular pip 22 serving as positive terminal. The upper end of the can 12 comprises the negative terminal and is hermetically sealed by a negative terminal cell closure assembly 60, which comprises a negative terminal end cap 24 formed from a thin metal sheet, a negative cap ring 23, a current collector nail 26 penetrating into the anode gel to provide electrical contact with the anode 18 and complete the electric circuit between the positive and negative terminals, a negative cap disc 25 that is electrically connected to the current collector nail 26 as well as to negative cap ring 23, and a top seal 28 made from a deformable water-impermeable electrically insulating material, such as a termoplastic, that electrically insulates the negative terminal end cap 24 from the can 12.

The negative cap disc 25 and negative cap ring 23 need not necessarily be circular, provided that electrical contact is made between at least a portion of the cap disc 25 and the cap ring 23 to complete the connection between the current collector nail 26 and the negative terminal end cap 24.

A bead or recess 30 is provided at the upper portion of the can 12 which, when viewed from outside, looks like a recessed ring. The radially inward projecting portion of bead 30 serves as an abutting member for the top seal 28 when inserted in the can 12. A substantially cylindrical gasket zone 31 is defined between the bead or recess 30 and ending in a crimped portion 32. The top seal 28 has a hollow cylindrical upper end zone 33 which is bent back as shown in the drawings, when the crimped portion 32 of the can is provided.

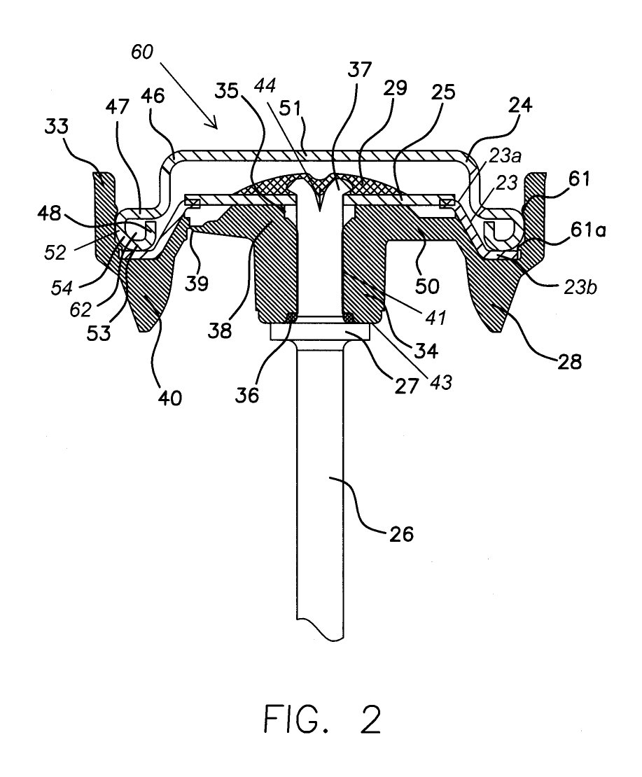

FIG. 2 shows an enlarged view of the upper portion of an LR6 closure assembly according to the invention illustrated in greater detail. The top seal 28 has a central portion 34 made substantially as a hollow cylinder. A first step 35 is provided in an axial bore 41 of the central portion 34 proximal an upper end of a top portion 37 of the current collector nail 26 and a second step 36 is provided proximal a lower end of top portion 37. First and second undercuts (61 and 61a) are provided in the inside sidewall of the upper end zone 33 of top seal 28, which act as a retaining feature for negative terminal end cap 24 and negative cap ring 23 during the assembly process. The nail 26 has a head 27 seated on a lower face 43 of the central portion 34 of the top seal 28. When assembled, the top portion 37 of the nail 26 is pressed and deformed to create a rivet having an interference fit with an inside diameter of a central aperture 44 through the negative cap disc 25, which provides a stable electrical contact between the nail 26 and the negative cap disc 25. The negative cap disc 25 is also pressed down against a top surface 23a of negative cap ring 23 and slightly compresses the central portion 34 between the disc 25 and the head 27 to form a preloaded pressure contact, which provides for a spring loaded, stable electrical connection between disc 25 and ring 23. An optional sealant 29, having electrical insulation properties, such as hotmelts, polyamides, asphalts and the like, can be applied to the riveted upper end of top portion 37 and the top surface of cap disc 25 to prevent inadvertent electrical contact between the nail 26 and the negative terminal end cap 24. The negative terminal end cap 24 is seated on top of an outer edge portion 23b of cap ring 23 and is held in place by first undercut 61. Negative terminal end cap 24 and cap ring 23 are in electrical contact and are attached to one another by a pressured fit after the closure assembly 60 is installed and crimped into place, as shown in FIG. 1. In another embodiment (not shown) the cap ring 23 is integrally formed with the negative terminal end cap 24.

Middle section 38 extends out from the central portion 34 to interconnect the central portion 34 of the top seal 28 with the outer portion thereof. The middle section 38 has a substantially uniform thickness as shown at reference numeral 50, with the exception of a blow out vent section 39, wherein the wall thickness is thinner. The thickness of the blow out vent section 39 is sufficient to resist a pressure limit of up to about 5 MPa, but it blows out if the pressure exceeds the pressure limit.

The internal surface of the lower rim 40 provides support and a guide for the upper end portion 42 of the separator 20 extending beyond the upper end of the anode 18.

The negative terminal end cap 24 is formed as an integral member from a metal sheet and comprises the following main portions: a central disc portion 51 forming the face, a short cylindrical portion 46 coaxial with the cell axis, and a flange portion 47 with an inwardly bent rim 48. The rim 48 has a cylindrical portion 52 fitting to the interior of the cylindrical end zone 33 of the top seal 28, a short ring portion 53 parallel to the flange 47, and an upwardly inclined flare portion 54 fitting to the conical outer surface of the lower rim 40 of the top seal 28. The flange 47 together with the inwardly bent rim 48 defines an almost closed channel 62, whereby this zone of the cap 24 can act as a resilient spring both in radial and axial directions.

Referring to FIG. 1, the radial components of the spring forces press the end zone 33 of the top seal 28 to the interior of gasket zone 31 of the can, which is covered by an appropriate sealant material, and this pressure maintains a substantially complete sealing effect. A shallow second circular recess or bead 30a is formed on the can at about the mid-point of the height of the gasket zone 31. The second bead 30a projects radially inward about the can and is created following the formation of the first bead 30 and the rim of crimped portion 32. The dominant part of the pressure between the inner wall of the can 12 and of the top seal 28 is established before the second bead 30a is formed. The formation of this latter bead provides a pressure profile in the wall of the cylinder gasket zone 31 which increases towards the middle of zone 31 from both directions. Since by this time the wall is already under a high pressure, this additional profiled pressure causes the material to flow and to completely fill any miniature groove or recess that might exist in the inner wall of the can 12. Such miniature grooves might otherwise become channels for the electrolyte and hence a source of future leakage. Any long term fatigue of the wall of the end zone 33 of the top seal 28 does not appreciably decrease the sealing effect, because the biasing force of the negative terminal end cap 24 maintains the required pressure. The axial components of the spring forces maintain pressure on the top seal 28 and the bead 30. It can be seen that the thin end zone 33 of the top seal 28 is exposed only to substantially evenly distributed pressure forces; and neither shearing forces nor sudden pressure peaks will act on the plastic seal material.

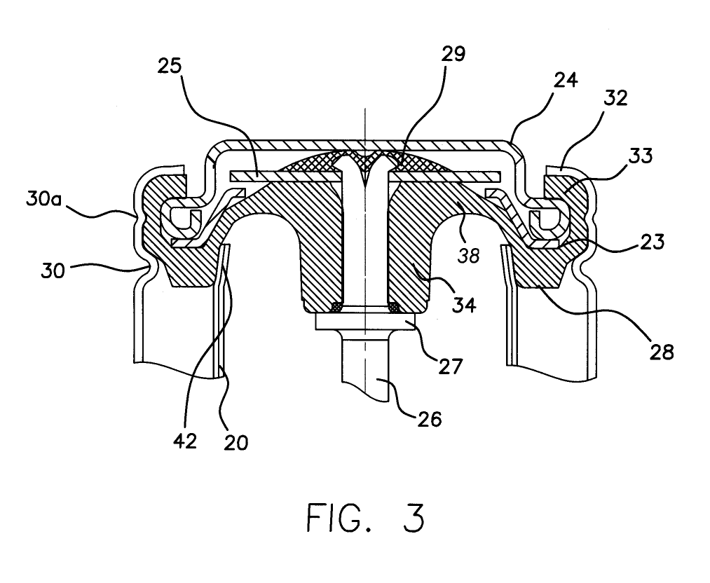

FIG. 3 shows an enlarged view of the upper portion of an LR6 cell according to the invention in an electrically disconnected state. When the pressure inside the cell increases (for example, as a result of the cell being abused due to an overcharge condition), this pressure acts on the underside of top seal 28. Nail head 27 and central portion 34 transfer this pressure, pushing the center portion of the assembly upwards. At a predetermined pressure, the cap disc 25 will disconnect from cap ring 23, thereby disconnecting the cell from the abuse condition by breaking the electric circuit. The abuse condition stops as a result of the electrical disconnect and no further pressure build-up occurs. The predetermined disconnect pressure of the disc/ring is set at about half the pressure limit of the blow-out safety vent 39, which substantially prevents any leakage from occurring through the safety vent 39. The adjustment of this disconnect pressure can be accomplished by altering the material thickness of the middle section 38 of the top seal 28. Accordingly, the pre-determined disconnect pressure may be about 2.5 MPa, about 3 MPa, about 3.5 MPa, about 4 MPa, from about 2 to about 4 MPa or from about 3 to about 4 MPa.

FIGS. 4a-c depict different disc types according to the invention. In FIG. 4a, a flat disc is shown. FIG. 4b shows a disc with concentric waved ribs, which provides for a stronger disc and can be advantageously used to adjust the disconnect pressure. In FIG. 4c, a disc with concentric ribs plus a curled lip 25a on an inside diameter of the central aperture 44 is shown, which provides for more interference with the nail 26 and allows for better control over part feeding in high speed production equipment. The preferred disc shape depends upon the cell size and the required disconnect pressures.

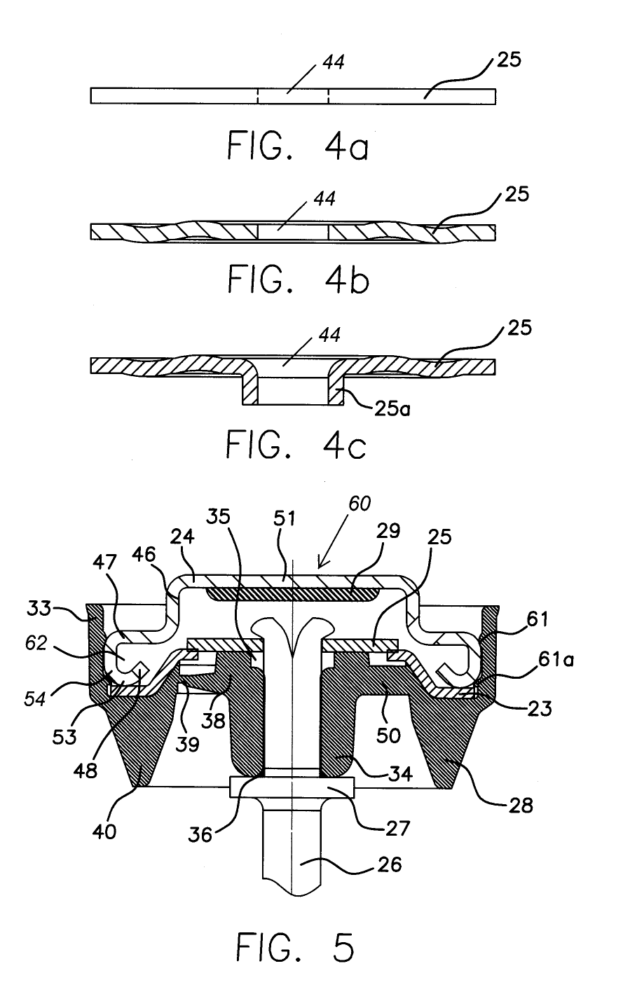

In FIG. 5, an LR03 (AAA type) closure assembly according to the invention is shown. The approach for the smaller diameter LR03 size cell is essentially the same as described above. However, in this embodiment, the insulator material 29 is applied to the underside of negative cap 24. The reference numerals shown in FIG. 5 describe the same features as shown and described with reference to FIG. 2.

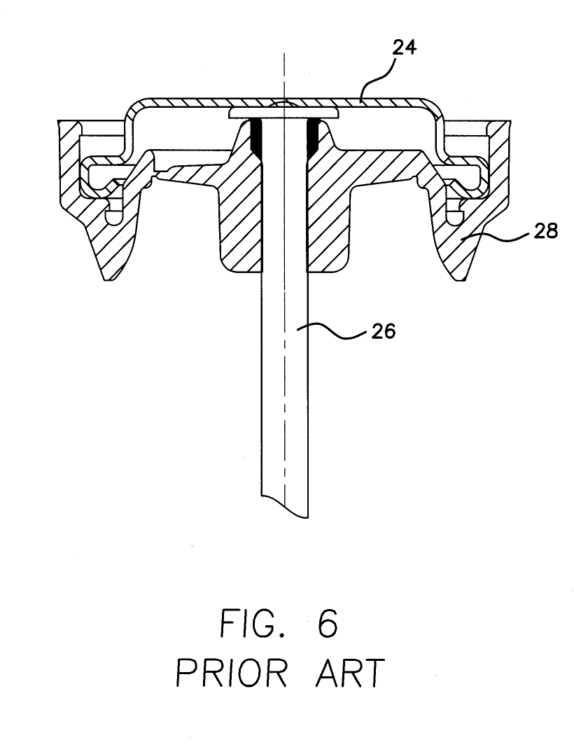

FIG. 6 shows a prior art LR6 closure assembly with the traditional welded connection between negative cap and current collector nail. In this prior art configuration, the negative terminal end cap 24 is directly connected to the current collector nail 26 and can therefore not stop the electrical connection at elevated internal cell pressures during abuse situations.

The mounting of the cell closure assembly 60 can be carried out as follows. The main elements of the cell, namely the cathode, separator and anode, are inserted into the can before the bead 30 is made. With the cell components substantially in their final positions, the bead 30 is provided by using an appropriate tool. The next step is the assembly of the top seal 28 with the negative cap ring 23. The current collector nail 26 is inserted through the bottom of central portion 34 and the negative cap disc 25, which is riveted to the nail 26 in order to create an interference fit. The portion above the nail head 27 is covered by an appropriate sealant (e.g., polyamide or asphalt) and recessed portion 36 of top seal 28 allows for excess sealant to accumulate. An optional sealant 29 that has electrically insulating properties, such as hotmelts, polyamides, asphalts and the like, can be used to separate the top portion 37 from the negative terminal end cap 24, which is placed on top of negative cap ring 23 and held in place by undercut 61 of top seal 28. The interior of the can at the gasket zone 31 is covered by a sealant, whereafter the top seal 28 together with the nail 26 is inserted into the cell, to a position as shown in the drawings, until the top seal 28 abuts the inner surface of the bead 30. The next step is the crimping of the upper end portion 32 of the can 12 over the bent rim 48 of the negative cap 24, so that the wall of the end zone 33 of the top seal 28 gets pressed between the two metals. The bead 30a may then be formed to create a pressure profile in seal 28.

The above described cell closure design desirably provides one or more of the following main advantages. A high degree of leakage prevention under normal use is provided by having a bias force pressing evenly against the thin end wall of the top seal, and this pressure is maintained if the plastic material relaxes (e.g., on elevated temperature) and loses its resiliency. Superior leakage prevention under abnormal usage and misuse is provided by having an electrical disconnect feature that interrupts electrical contact between the positive and negative terminals of the cell, thereby halting electrochemical reactions within the cell and avoiding further pressure build up. This keeps internal cell pressure below the blow out safety-vent pressure limit. The cell advantageously automatically re-connects when the internal cell pressure decreases by a pre-determined fraction of the disconnect pressure, such as about 10 to 15%, for example through the action of a hydrogen recombination catalyst provided in the cathode mix.

### Example 1

To confirm the operating characteristics of cells comprising the cell closure structure according to the invention, LR6 size test cells were made with the inventive closure assemblies. The can 12 was provided with a sealed connection to a high pressure gas source (i.e. high pressure nitrogen tank) through a small drilled opening in the sidewall of can 12, and the inner gas pressure was increased until the blow out safety vent opened and the pressure values were recorded. The blow out pressure of the vent 39 was measured in the range of 5 to 9 MPa, and a safe venting effect was experienced. The decrimp strength of this cell construction was measured similarly, except that a top seal 28 without the vent 39 (i.e. it was made with uniform thickness and no thin section) was used. When pressurized, the test cells were able to hold a pressure of 13 MPa and at pressures higher than 13 MPa the cell would decrimp. The term decrimp means that the crimped portion 32 of the can 12 is no longer strong enough to contain the closure assembly within the closed cell and the whole closure assembly 60 separates from the cell. Having a high blow out vent pressure that is still well below the decrimp pressure provides for a very safe cell closure structure.

### Example 2

To establish the electrical disconnect pressure of the closure assembly 60, a special test fixture was built wherein the closure was mounted so that electrical current could be applied through the current conducting path of collector nail 26, negative cap disc 25, negative cap ring 23 and negative cap 24. An electric current of 1 ampere was applied in this circuit from a DC power supply and monitored with an ampere-meter connected in series with the circuit. The fixture was sealed and pressure from a compressed air tank was applied to the underside of top seal 28 and monitored via a pressure gauge. As the pressure was gradually increased, the central portion 34 of top seal 28 was pushed upwards and assisted by nail head 27 of current collector nail 26. When the closure assembly reached its switching pressure, the ampere-meter current reading dropped to zero, confirming that the closure assembly disconnected the circuit path and prevented further current flow. The measured switching pressure was in the range of 2 to 4 MPa depending on the type of top seal 28, negative cap ring 23 and negative cap disc 25 used.

Following switching to zero current, the pressure in the fixture was gradually released and the pressure gauge and ampere meter readings were monitored. When the pressure dropped by approximately 300 to 400 kPa, the electrical contact between negative cap ring 23 and negative cap disc 25 was re-established, allowing a current of 1 Ampere to again flow through the electrical circuit. These off/on switching cycles were repeated with the same closure assembly for up to 10 times to ensure that the mechanism worked repeatably. When the closure assembly of the present invention is used in rechargeable alkaline cells, the practical effect of these tests is that the cell will still be usable after it is abused, once the internal pressure dissipates and electrical contact is restored.

The switching pressure of the closure assembly is preferably in the range of 3 to 3.5 MPa, which provides good electrical contact during normal operation of the cell, but is still well below the blow out safety-vent pressure in order to avoid premature venting and destructive cell leakage.

### Example 3

Comparative abuse tests were carried out with LR6 size cells made with closure assemblies according to the present invention, using a test that simulates incorrect cell installation. A 12V/20 W Halogen Light requiring 8 cells in series to operate was used for this test. Seven (7) cells were installed observing correct polarity and one (1) cell was installed with reversed polarity. An ampere current meter was connected in series with the cells to measure the current flowing through the electrical circuit and showed that an initial current of 1.5 Amperes was present. Since one cell was installed incorrectly (not observing proper polarity), this cell experienced the 1.5 A current as a forced overcharge current. In turn, this caused the cell to develop internal gas pressure, due to oxygen or hydrogen gas generation (depending on the state and chemical makeup of the incorrect installed cell) by electrolysis of the aqueous alkaline electrolyte. Cells made according to the invention showed current flowing through the cell until the internal pressure reached the switching point of closure assembly 60 and negative disc 25 was separated from cap ring 24 causing an open circuit condition and the forced overcharge condition stopped. As a result, no further pressure was generated and the cell remained leak-free.

Comparative abuse testing with commercially available single-use alkaline LR6 cells from Duracell™ and Energizer™ was carried out using the same 12V/20 W Halogen Light test. Both leading brand single-use alkaline LR6 batteries showed severe leakage after the blow out safety vent of these cells opened, due to gas generation from the abusive overcharge condition.

### Example 4

Further comparative abuse tests were carried out with LR6 and L03 size rechargeable alkaline cells using a standard charger for nickel cadmium (NiCd) or nickel metal hydride (NiMH) batteries. This type of charger is not approved for rechargeable alkaline cell charging, due to incorrect charge voltage. Charging rechargeable alkaline cells with a standard NiCd or NiMH charger therefore results in an overcharge condition, which causes the rechargeable alkaline cell to develop internal gas pressure. Two groups of rechargeable alkaline cells were prepared in the lab; one group had the traditional closure (with blow-out safety vent only) and the other group had the pressure responsive electrically disconnecting closure according to the present invention. Fully charged rechargeable alkaline LR03 and LR6 size batteries of each group where inserted in a standard NiCd charger (Kolvin Industries Ltd., Model KB18DF5, UL File # E303954) and charging was commenced by plugging the charger into mains power. After about 30 minutes in the charger, the groups with the traditional, prior art closure vented and leaked from excessive pressure, whereas the groups with the closure of the present invention did not vent or leak. The test continued for 24 hours and the cells made according to the present invention still did not leak.

### Example 5

Functionality under normal use conditions was verified with LR6 (AA) size single-use (primary) alkaline cells. Two groups of primary alkaline cells were prepared in the lab; one group had the traditional closure (with blow-out safety vent only) and the other group had the pressure responsive electrically disconnecting closure according to the present invention. Service time was measured on three application tests, the radio, audio and toy tests, as specified by the international standard for primary batteries IEC 60086. In these application tests a constant resistor load (radio=43 ohm, audio=10 ohm, toy=3.9 ohm) is applied and the cells are discharged until they reach the specified end point voltage (radio=0.9V, audio=0.9V, toy=0.8V). The service time to the end point is reported. Results from these three application tests showed that the two test groups performed within normal variations of the test equipment and the service times were measured within 3% of each other.

### Example 6

Functionality under normal use conditions in a rechargeable cell was verified with LR6 (AA) size rechargeable alkaline cells. Two groups of rechargeable alkaline cells were prepared in the lab; one group had the traditional closure (with blow-out safety vent only) and the other group had the pressure responsive electrically disconnecting closure according to the present invention. Service time was measured on the aforementioned audio test (10 ohm to 0.9V end-point) over a total of 50 discharge-recharge cycles. One cycle consisted of a discharge to the 0.9V end-point, followed by a recharge to a constant voltage of 1.75V for 12 hours. The sum of the service times in each of these 50 discharge-recharge cycles was tabulated and reported. The results of these discharge-recharge cycle tests showed that the two test groups performed within normal variations of the test equipment and the service times were measured within 4% of each other.

1. A sealed electrochemical cell containing an aqueous alkaline electrolyte, the cell comprising:
a. a cylindrical can;
b. a positive terminal;
c. a negative terminal comprising a negative terminal closure assembly, the negative terminal closure assembly comprising
i. a negative terminal end cap,
ii. a negative cap disc located within an interior of the cell spaced apart from the negative terminal end cap,
iii. a negative cap ring electrically connected to the negative terminal end cap, at least a portion of the negative cap ring in unsecured electrical contact with the negative cap disc;
d. a current collector nail within the cell electrically connected to the negative cap disc that completes an electric circuit between the positive and negative terminals of the cell; and,
e. wherein the negative cap disc is movable away from the negative cap ring in response to an increase in internal cell pressure to thereby electrically disconnect the negative cap disc from the negative terminal end cap and interrupt the electric circuit within the cell.

2. The cell as claimed in claim 1, wherein the negative terminal end cap is pressed against the negative cap ring.

3. The cell as claimed in claim 1, comprising a gasket zone proximal the negative terminal formed between a first radial bead and a crimped portion of the can, the gasket zone having at about its mid-point a second radial bead.

4. The cell as claimed in claim 1, wherein a top portion of the current collector nail is riveted to the negative cap disc.

5. The cell as claimed in claim 1, wherein the negative cap disc is in preloaded pressure contact with the negative cap ring.

6. The cell as claimed in claim 1, wherein the cell further comprises a top seal.

7. The cell as claimed in claim 6, wherein the increase in internal cell pressure deforms the top seal to move the negative cap disc away from the negative cap ring.

8. The cell as claimed in claim 6, wherein the cell is electrically disconnected at a predetermined pressure.

9. The cell as claimed in claim 8, wherein the top seal comprises a blow out vent created at a thin section of the top seal.

10. The cell as claimed in claim 9, wherein the predetermined pressure is about one half of the pressure required to rupture the blow out vent.

11. The cell as claimed in claim 8, wherein the pre-determined pressure is from about 3 to about 4 MPa.

12. The cell as claimed in claim 8, wherein the negative cap disc re-connects with the negative cap ring upon a pressure decrease of from 10 to 15% of the predetermined pressure.

13. The cell as claimed in claim 6, wherein the current collector nail comprises a nail head that pushes against a lower face of the top seal.

14. The cell as claimed in claim 6, wherein a sealant is placed between a central bore of the top seal and the current collector nail.

15. The cell as claimed in claim 1, wherein the negative cap disc has concentric waved ribs.

16. The cell as claimed in claim 1, wherein the negative cap disc has a curled lip on an inside diameter of a central aperture.

17. The cell as claimed in claim 1, wherein an electrically insulating material is disposed between a top portion of the current collector nail and an underside of the negative terminal end cap.

18. The cell as claimed in claim 1, where said cell is an alkaline manganese dioxide-zinc cell.

19. The cell as claimed in claim 18, wherein said cell is a primary cell.

20. The cell as claimed in claim 18, wherein said cell is a rechargeable cell.

21.-43. (canceled)
